(19) United States
(12) Patent Application Publication
(10) Pub. No.: US 2021/0010555 A1
(43) Pub. Date: Jan. 14, 2021

(54) FRICTION PART

(71) Applicant: Schaeffler Technologies AG & Co. KG, Herzogenaurach (DE)

(72) Inventor: Philipp Tepper, Buehl (DE)

(73) Assignee: Schaeffler Technologies AG & Co. KG, Herzogenaurach (DE)

(21) Appl. No.: 17/042,527

(22) PCT Filed: Jan. 22, 2019
(86) PCT No.: PCT/DE2019/100060

§ 371 Date: Sep. 28, 2020

(30) Foreign Application Priority Data
Apr. 5, 2018 (DE) 10 2018 108 018.2
Dec. 7, 2018 (DE) 10 2018 131 413.2

(51) Int. Cl. F16D 69/00

(52) U.S. Cl. CPC F16D 69/00; F16D 65/127

(57) ABSTRACT

A friction part includes a friction surface with a first row of first friction lining pieces arranged radially inwardly, a second row of second friction lining pieces arranged between the first friction lining pieces and a third row of third friction lining pieces, and the third row of third friction lining pieces arranged radially outwardly. Stem grooves are formed between adjacent pairs of the first friction lining pieces. Radially inner branch grooves emerge from the stem grooves and are delimited by the adjacent pairs of the first friction lining pieces and by the second friction lining pieces. Radially outer branch grooves are delimited by the second friction lining pieces and the third friction lining pieces. The radially inner branch grooves and the radially outer branch grooves are connected to each other by offset grooves with a tangential offset between the radially inner branch grooves and the radially outer branch grooves.

### CROSS-REFERENCE TO RELATED APPLICATIONS

This application is the United States National Phase of PCT Appln. No. PCT/DE2019/100060 filed Jan. 22, 2019, which claims priority to German Application Nos. DE102018108018.2 filed Apr. 5, 2018 and DE102018131413.2 filed Dec. 7, 2018, the entire disclosures of which are incorporated by reference herein.

### TECHNICAL FIELD

The disclosure relates to a friction part for a frictionally operating device, with friction lining pieces which are arranged spaced apart from one another by means of grooves for the purpose of representing an annular disk-like friction surface arranged in three rows which extend in the circumferential direction. In a first row the first friction lining pieces are arranged radially inwardly, and in a second row the second friction lining pieces are arranged between the first friction lining pieces and the third friction lining pieces, which are arranged radially outwardly in a third row. In the circumferential direction, stem grooves are formed between the two first friction lining pieces in the first row, from which radially inner branch grooves emerge, which are delimited by the first friction lining pieces in the first row and by the second friction lining pieces in the second row. The second friction lining pieces in the second row and the third friction lining pieces in the third row delimit radially outer branch grooves.

### BACKGROUND

From European patent specification EP 2 066 911 B1, a friction part for a frictionally operating device having an annular friction face which has an inner edge and an outer edge is known. In the friction face, at least one set of grooves is provided with a first groove which extends from the inner edge or the outer edge to a branching point between the inner edge and the outer edge, and with a second and third groove which each extend from the branching point to the other edge.

From the German patent specification DE 103 42 271 B4, a friction lining plate for a wet-running friction shift element is known, having at least one annular disk-shaped friction surface which provides frictional engagement and has grooves through which coolant flows from the inner diameter of the friction surface. The grooves form two overlapping groove sets. The grooves of a second groove set intersect only with three grooves of a first groove set at a respective groove intersection point. A first groove intersection point lies on the friction surface's inner diameter, a second groove intersection point lies on the friction surface's outer diameter, and the total groove cross-sectional area on the friction surface's inner diameter is smaller than the total groove cross-sectional area on a friction surface diameter between the friction surface's inner diameter and the friction surface's outer diameter.

From the German patent application DE 10 2012 014 804 A1, a friction part for a frictionally operating device with an annular friction surface having an inner edge and an outer edge is known. A circumferential first groove, which extends in a zigzag or wavy manner between radially inner and radially outer first deflection points, and a circumferential second groove placed radially outside the circumferential first groove, which extends in a zigzag or wavy manner between radially inner and radially outer second deflection points, are provided on the friction surface. A flow connection is provided between the inner edge and the first circumferential groove, between the first circumferential groove and the second circumferential groove, and between the second circumferential groove and the outer edge. The first and second grooves are spaced apart from each other, and a plurality of connection grooves are provided between the first and second grooves to achieve the flow connection between the first and second grooves.

### SUMMARY

The disclosure provides a friction part for a frictionally operating device with friction lining pieces which are arranged spaced apart from one another by means of grooves for the purpose of representing an annular disk-like friction surface arranged in three rows which extend in the circumferential direction. In a first row, the first friction lining pieces are arranged radially inwardly, and in a second row, the second friction lining pieces are arranged between the first friction lining pieces and the third friction lining pieces, which in a third row are arranged radially outwardly. In the circumferential direction, stem grooves are formed between two first friction lining pieces in the first row, from which radial inner branch grooves emerge. The radial inner branch grooves are delimited by the first friction lining pieces in the first row and by the second friction lining pieces in the second row. The second friction lining pieces in the second row and the third friction lining pieces in the third row delimit radially outer branch grooves for improved producibility and/or functionality, for example.

A friction part for a frictionally operating device, includes friction lining pieces which, for the purpose of representing an annular disk-like friction surface, are arranged spaced apart from one another by means of grooves and arranged in three rows which extend in the circumferential direction. In a first row, the first friction lining pieces are arranged radially inwardly, and in a second row, the second friction lining pieces are arranged between the first friction lining pieces and the third friction lining pieces, which are arranged radially outwardly in a third row.

In the circumferential direction, stem grooves are formed between two first friction lining pieces in the first row, from which radially inner branch grooves emerge, delimited by the first friction lining pieces in the first row and by the second friction lining pieces in the second row. The second friction lining pieces in the second row and the third friction lining pieces in the third row delimit radially outer branch grooves, in that the radially inner and the radially outer branch grooves are connected to each other by offset grooves having a direction component in the circumferential direction to present a tangential offset between the radially inner branch grooves and the radially outer branch grooves. The stem grooves may extend, at least substantially, in a radial direction. The term radial refers to an axis of rotation of the friction part. The term circumferential direction also refers to the axis of rotation of the friction part. The term tangential refers to a tangent to a circumference of the friction part.

The branch grooves start at the radially outer ends of the stem grooves. A stem groove represents a y-shaped branching in the friction part with two radially inner branch grooves. The offset grooves serve to provide flow barriers between the first and third friction lining pieces. The offset grooves provide a simple means of forced deflection of a fluid, e.g., cooling oil, which flows through the grooves of the friction part during operation of the friction part. During operation of the friction part, a flow of an oil/air mixture is generated in the grooves, which is used to cool the friction part. The offset in a tangential direction represented by the offset grooves has proved to be advantageous for both cooling and the coefficient of friction curve in the experiments and investigations carried out within the context of the present disclosure, e.g., with regard to an undesirable tendency to float and/or a contact friction coefficient.

An exemplary embodiment of the friction part includes offset grooves with a direction component radially outward. The offset grooves may extend diagonally radially outward between the radially inner branch grooves and the radially outer branch grooves. Due to the radial direction component of the offset grooves, in addition to the tangential offset, a radial offset between the radially inner and the radially outer branch grooves is also shown.

Another exemplary embodiment of the friction part includes offset grooves forming an angle between five degrees and twenty degrees relative to a tangent to a circumferential line running between the first and third friction lining. This angular range has proved to be effective in the investigations and experiments carried out within the context of the present disclosure with regard to the desired flow pattern.

Another exemplary embodiment of the friction part includes grooves, e.g., the offset grooves, with a length which is less than half the length of the radially inner branch grooves and/or the radially outer branch grooves. The length is defined as a dimension of the offset grooves in the direction of their longitudinal extension. Likewise, no dimension transverse to the longitudinal extension of the grooves, e.g., the offset grooves, is referred to as groove width. The claimed length selection has proven to be advantageous in the experiments and investigations carried out in the context of the present disclosure.

A friction part for a frictionally operating device includes friction lining pieces which, for the purpose of representing an annular disk-like friction surface, are arranged spaced apart from one another by means of grooves and are arranged in three rows which extend in the circumferential direction. In a first row, the first friction lining pieces are arranged radially inwardly, and in a second row, the second friction lining pieces are arranged between the first friction lining pieces and the third friction lining pieces, which are arranged radially outwardly in a third row. In the circumferential direction, stem grooves are formed between two first friction lining pieces in the first row, from which radially inner branch grooves emerge, which are delimited by the first friction lining pieces in the first row and by the second friction lining pieces in the second row. The second friction lining pieces in the second row and the third friction lining pieces in the third row delimit radially outer branch grooves.

The second friction lining pieces have greater expansion in the radial direction than the third friction lining pieces. This has proved to be advantageous in the experiments and investigations carried out within the context of the present disclosure.

A friction part for a frictionally operating device includes friction lining pieces which, for the purpose of representing an annular disk-like friction surface, are arranged spaced apart from one another by means of grooves are arranged in three rows which extend in the circumferential direction. In a first row, the first friction lining pieces are arranged radially inwardly, and in a second row, the second friction lining pieces are arranged between the first friction lining pieces and the third friction lining pieces, which are arranged radially outwardly in a third row. In the circumferential direction, stem grooves are formed between two first friction lining pieces in the first row, from which radial inner branch grooves emerge, which are delimited by the first friction lining pieces in the first row and by the second friction lining pieces in the second row. The second friction lining pieces in the second row and the third friction lining pieces in the third row delimit radially outer branch grooves.

The friction lining pieces have the shape of triangles, pentagons and hexagons. The corners of triangular, pentagonal, and hexagonal friction lining pieces may be rounded. The first friction lining pieces may be pentagonal with a point that is directed radially outward. The second friction lining pieces may be diamond-shaped or diamond-shaped with an elongated central area. The third friction lining pieces may be triangular with a radially inward point or pentagonal with a radially inward point. The first and the third friction lining pieces with their inner and outer edges represent a radially inner and a radially outer circumferential edge of the friction lining surface.

Another exemplary embodiment of the friction part includes first and third friction lining pieces with smaller dimensions in the radial direction than the second friction lining pieces. The second friction lining pieces may have larger dimensions in the radial direction than in the circumferential direction. This choice of dimensions has proved to be advantageous in the experiments and investigations carried out within the context of the present disclosure with regard to the coefficient of friction behavior or the coefficient of friction curve over the friction part.

According to another exemplary embodiment, the radially inner and the radially outer branch grooves are offset but arranged parallel to each other.

According to another exemplary embodiment, the radially inner and the radially outer branch grooves are offset and arranged at an acute angle to each other. The angle between the radially outer branch grooves and the radially inner branch grooves may be less than forty degrees.

Another exemplary embodiment of the friction part is includes radially inner branch grooves and radially outer branch grooves with different groove widths. The different groove widths may be realized in a particularly simple way by arranging the second friction lining pieces in the second row radially offset in relation to the first and third friction lining pieces in the first and third rows. This makes it easy to set a desired coefficient of friction curve via the friction part.

Another exemplary embodiment of the friction part includes second friction lining pieces that are substantially diamond-shaped. One point of the diamond shape may be arranged radially outward, while another point of the diamond shape may be arranged radially inward.

Another exemplary embodiment of the friction part includes second friction lining pieces with a substantially hexagonal shape. The hexagonal shape results from an elongation of a diamond shape in the center. This leads to a groove proportional curve, which is largely constant in the central part. The second or central friction lining pieces or pads are not too wide tangentially, which counteracts the floating effect. In addition, three-row pad patterns or friction lining patterns can be used instead of four-row designs. This reduces the cost of producing the friction part.

According to another aspect of the disclosure, radially outer stem grooves are formed radially outward between the third friction lining pieces. Two radially outer branch grooves meet at a branching point, from which a radially outer stem groove then begins. This results in an inverted y-shaped branching radially outward. This allows further optimization, which may be necessary in individual cases, with regard to the possible inclination of the friction system of friction lining/cooling oil and a steel plate surface to high static friction values.

### BRIEF DESCRIPTION OF THE DRAWINGS

Further advantages, features and details of the disclosure emerge from the following description, in which various exemplary embodiments are described in detail with reference to the drawings. In the figures:

FIG. 1 shows a top view of a section of a friction part for a frictionally operating device with an annular friction surface formed by friction lining pieces which are designed and arranged according to a first groove design;

FIG. 2 shows a top view of a section of a friction part for a frictionally engaged device with an annular friction surface formed by friction lining pieces which are designed and arranged according to a second groove design; and

FIG. 3 shows a top view of a section of a friction part for a frictionally engaged device with an annular friction surface formed by friction lining pieces which are designed and arranged according to a third groove design.

### DETAILED DESCRIPTION

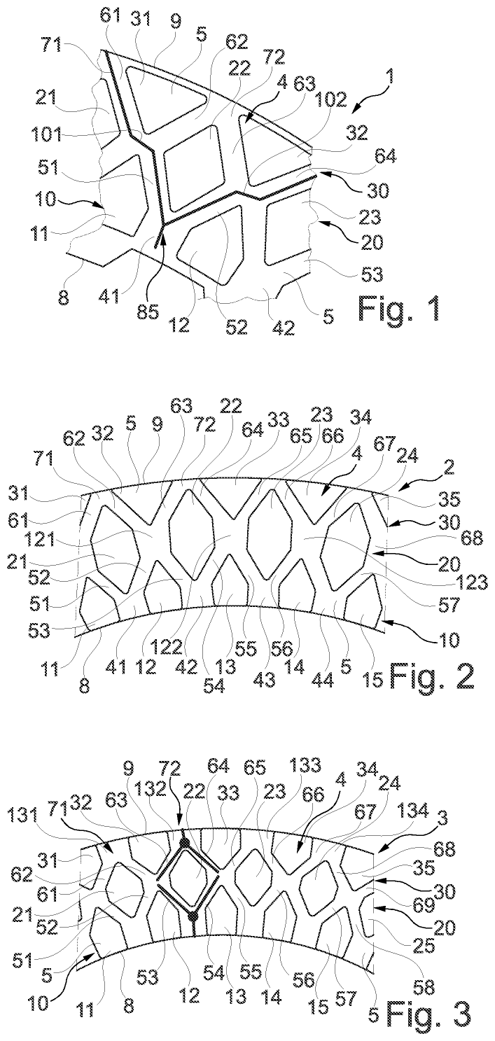

FIGS. 1 to 3 show a friction part 1; 2; 3 with three different groove constructions or groove patterns. The same reference symbols are used in FIGS. 1 to 3 to denote identical or similar parts. To avoid repetition, common features of the exemplary embodiments or groove designs are described only once in FIGS. 1 to 3. Following the description of the common features of the exemplary embodiments, the differences between the three exemplary embodiments or groove designs of the friction parts 1; 2; 3 are explained.

The friction part 1; 2; 3 comprises a friction lining 4, which is composed of the individual friction lining pieces 11 to 15; 21 to 25; 31 to 35. The friction lining pieces 11 to 15; 21 to 25; 31 to 35 are bonded to a friction lining carrier 5 in such a way that the gaps between the friction lining pieces 11 to 15; 21 to 25; 31 to 35 represent grooves in a friction lining 4. The friction lining 4 represents a grooved friction surface 6, which has an inner edge 8 and an outer edge 9.

During operation of the friction part 1; 2; 3, a fluid, in particular cooling oil, enters the friction lining 4 at the inner edge 8, flows through the grooves in the friction lining 4 on the friction lining carrier 5 between the friction lining pieces 11 to 15; 21 to 25; 31 to 35 for cooling, and exits again at the outer edge 9 of the friction lining 4.

The friction part 1; 2; 3 is, for example, a plate of a multi-plate clutch or a multi-plate brake. The plate may be equipped on both sides with the friction lining 4, so that two friction surfaces 6 are provided. In the multi-plate brake, the friction part 1; 2; 3 is arranged between two steel plates which can be frictionally connected to the friction part 1; 2; 3 in order to transmit a torque.

The friction lining pieces 11 to 15; 21 to 25; 31 to 35 are arranged in three rows 10, 20; 30. The first friction lining pieces 11 to 15 are arranged radially inwardly in a first row 10. The second friction lining pieces 21 to 25 are arranged in a second row 20 between the first friction lining pieces 11 to 15 and the third friction lining pieces 31 to 35. The third friction lining pieces 31 to 35 are arranged in a third row 30. The friction lining pieces 11 to 15; 21 to 25; 31 to 35 are evenly spaced apart in the three rows 10, 20, 30 in the circumferential direction.

The first friction lining pieces 11 to 15 each have an essentially straight edge radially inwardly, which represents the inner edge 8 of the friction surface 6. The friction lining pieces 31 to 35 also have an essentially straight edge radially outwardly, which represents the outer edge 9 of the friction surface 6.

The first friction lining pieces 11 to 15 have the shape of pentagons, each of which are composed of a square and a triangle with the tip pointing radially outwardly. The squares of the pentagonal friction linings 11 to 15 are spaced apart from each other in the circumferential direction so that a stem groove 41 to 44 is left free between two of the friction lining pieces 11 to 15. The stem grooves 41 to 44 run in a radial direction.

At the radially inner ends of the stem grooves 41 to 44, the liquid enters the friction lining 4 during operation of the friction part 1; 2; 3. Two branch grooves 51, 52; 53, 54; 55, 56; 57 each start from the radially outer ends of the stem grooves 41 to 44. The stem grooves 41 to 44 each represent a y-shaped branching with two connected branch grooves 51, 52; 53, 54; 55, 56; 57.

The radially inner branch grooves 51 to 57 are limited in the first row 10 by the first friction lining pieces 11 to 15 and in the second row 20 by the second friction lining pieces 21 to 25. The radially outer branch grooves 61 to 69 are limited by the second friction lining pieces 21 to 25 in the second row 20 and by the third friction lining pieces 31 to 35 in the third row 30. The radially outer branch grooves meet in the discharge areas 71, 72 at the outer edge 9 of the friction surface 6, where the fluid emerges from the friction lining 4.

During operation of the friction part 1; 2; 3, a cooling oil/air mixture flows in the grooves past the friction lining carrier 5. Experiments and investigations carried out within the context of the present disclosure have shown that it can be advantageous both for cooling and for the coefficient of friction curve of the friction surface 6 to design the course of the grooves in such a way that the radially inner branch grooves 51 to 57 and the radially outer branch grooves 61 to 69 do not meet or cross each other at one point, but are arranged offset in a tangential direction.

FIG. 1 shows that the radially inner branch grooves 51 to 57 are connected to the radially outer branch grooves 61 to 69 by offset grooves 101, 102. Lines 85 in FIG. 1 show a flow path of the oil/air mixture within the grooves of friction lining 4. The oil/air mixture enters the friction lining 4 on the flow path 85 through the stem groove 41.

At the radially outer end of the stem groove 41, the flow path 85 branches off into the two radially inner branch grooves 51 and 52. At the end of the branch groove 51, the offset groove 101 represents a kind of flow barrier. Similarly, the offset groove 102 at the end of the radially inner branch groove 52 represents a flow barrier. From the offset grooves 101, 102 the flow path 85 then runs via the radially outer branch grooves 61, 64 to the outer edge 9 of the friction surface 6, where the oil/air mixture emerges at the discharge areas 71.

In the experiments and investigations carried out within the context of the present disclosure, it has also been shown that it can be advantageous, for example in the case of radially large annular disk-like friction surfaces 6, to radially stretch the second friction lining pieces 21 to 25 in the second row 20 in the middle, which are essentially diamond-shaped in FIGS. 1 to 3, in such a way that hexagonal friction lining pieces 21 to 24 are formed.

Due to the radial expansion of the diamond-shaped friction lining pieces 21 to 24 in the center, connection areas 121, 122, 123 are created between the radially inner branch grooves 51 to 57 and the radially outer branch grooves 61 to 68, which represent radially running connection grooves with a relatively large groove width. This results in a groove proportional curve in the circumferential direction between the second friction lining pieces 21 to 24 in FIG. 2, which is essentially constant in the second row 20.

The friction lining pieces or pads 21 to 24 in the second row 20 are tangential, i.e., not too wide in the circumferential direction, which counteracts an undesirable floating effect. In addition, three-row friction lining patterns or pad patterns can be used instead of four-row groove patterns, which has a positive effect on production costs.

In FIGS. 1 and 2, the friction lining pieces 31 to 35 in the third row 30 have the shape of triangles with tips pointing radially inward. In FIGS. 1 to 3, the friction lining pieces 11 to 15 in the first row 10 have the shape of pentagons, each of which are composed of a square and a triangle with the tip pointing radially outward.

The friction linings 21 to 25 in the second row 20 are diamond-shaped in FIGS. 1 to 3, wherein the diamond shape of the friction lining pieces 21 to 24 in FIG. 2 is stretched in the radial direction in the center of each row.

In the friction part 3 shown in FIG. 3, the friction surface 6 is provided with radially outer stem grooves 131 to 134, which represent discharge grooves for the oil/air mixture. The diagonally running radially outer branch grooves 61 to 68 first meet at a branching point.

The oil/air mixture then flows in a closed system through the stem grooves 31 to 34 and out of the friction surface 6. This variant enables further optimization, which is necessary in individual cases, with regard to a possible inclination of the friction system consisting of the friction lining 4, oil and steel plate surface to high static friction values.

### REFERENCE NUMERALS

1 Friction part
2 Friction part
3 Friction part
4 Friction lining
5 Friction lining carrier
6 Friction surface
8 Inner edge
9 Outer edge
10 Row
11 Friction lining piece
12 Friction lining piece
13 Friction lining piece
14 Friction lining piece
15 Friction lining piece
20 Row
21 Friction lining piece
22 Friction lining piece
23 Friction lining piece
24 Friction lining piece
25 Friction lining piece
30 Row
31 Friction lining piece
32 Friction lining piece
33 Friction lining piece
34 Friction lining piece
35 Friction lining piece
41 Stem groove
42 Stem groove
43 Stem groove
44 Stem groove
51 Branch groove (inner)
52 Branch groove (inner)
53 Branch groove (inner)
54 Branch groove (inner)
55 Branch groove (inner)
56 Branch groove (inner)
57 Branch groove (inner)
61 Branch groove (outer)
62 Branch groove (outer)
63 Branch groove (outer)
64 Branch groove (outer)
65 Branch groove (outer)
66 Branch groove (outer)
67 Branch groove (outer)
68 Branch groove (outer)
69 Branch groove (outer)
71 Discharge area
72 Discharge area
85 Flow path
101 Offset groove
102 Offset groove
121 Connection area
122 Connection area
123 Connection area
131 Stem groove
132 Stem groove
133 Stem groove
134 Stem groove

1.-10. (canceled)

11. A friction part for a frictionally operating device comprising:
an annular disk-like friction surface comprising:
a first row of first friction lining pieces extending in a circumferential direction and arranged radially inwardly;
a second row of second friction lining pieces extending in the circumferential direction and arranged between the first friction lining pieces and a third row of third friction lining pieces;
the third row of third friction lining pieces extending in the circumferential direction and arranged radially outwardly;
stem grooves formed in the circumferential direction between adjacent pairs of the first friction lining pieces;
radially inner branch grooves emerging from the stem grooves, delimited by the adjacent pairs of the first friction lining pieces and by the second friction lining pieces; and
radially outer branch grooves delimited by the second friction lining pieces and the third friction lining pieces, wherein the radially inner branch grooves and the radially outer branch grooves are connected to each other by offset grooves having a direction component in the circumferential direction that provides a tangential offset between the radially inner branch grooves and the radially outer branch grooves.

12. The friction part of claim 11, wherein the offset grooves comprise a direction component radially outward.

13. The friction part of claim 12, wherein the offset grooves form an angle between five degrees and twenty degrees relative to a tangent to a circumferential line extending between the first friction lining pieces and the third friction lining pieces.

14. The friction part of claim 11, wherein the offset grooves have a length which is less than half the length of the radially inner branch grooves or the radially outer branch grooves.

15. The friction part of claim 11, wherein the second friction lining pieces have a greater expansion in a radial direction than the third friction lining pieces.

16. The friction part of claim 11, wherein:
the first friction lining pieces are shaped as triangles, pentagons or hexagons;
the second friction lining pieces are shaped as triangles, pentagons or hexagons; and
the third friction lining pieces are shaped as triangles, pentagons or hexagons.

17. The friction part of claim 11, wherein the first friction lining pieces and the third friction lining pieces have smaller dimensions in a radial direction than the second friction lining pieces.

18. The friction part of claim 11, wherein the radially inner branch grooves and the radially outer branch grooves have different groove widths.

19. The friction part of claim 11, wherein the second friction lining pieces are substantially diamond-shaped.

20. The friction part of claim 11, wherein the second friction lining pieces have a substantially hexagonal shape.
